(19) United States
(12) Patent Application Publication
(10) Pub. No.: US 2006/0101261 A1
(43) Pub. Date: May 11, 2006

(54) Security router system and method of authenticating user who connects to the system

(76) Inventors: Sang Woo Lee, Daejeon-city (KR); Yong Sung Jeon, Daejeon-city (KR); Young Ho Kim, Daejeon-city (KR); Jeong Nyeo Kim, Daejeon-city (KR); Jong Soo Jang, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/220,887

(22) Filed: Sep. 7, 2005

(30) Foreign Application Priority Data
Nov. 11, 2004 (KR) 10-2004-0091838

(51) Int. Cl. H04L 9/00

(52) U.S. Cl. 713/153

(57) ABSTRACT

Provided are a security router system for a network and a method of authenticating a user who connects to the system. The security routing system includes: a plurality of physical link ports inputting/outputting packets; a physical layer matching unit transmitting/receiving packets to the physical link ports and generating a media access control (MAC) frame; and a network processor including routing processing means that establishes a transport route for input packets via the physical layer matching unit and processes routing protocols, packet forwarding means that forward the input packets to their destinations, intrusion detection means that classify the input packets based on a packet classification standard and determine whether the input packets are attacks from outside, and user authentication means that determine whether a user is authorized to connect to a router, thereby reducing expenses required to build a network while maintaining security in comparison with a conventional firewall or intrusion detection system, and increasing reliability and safety of the network by preventing harmful traffic since each router performs a network security function.

### BACKGROUND OF THE INVENTION

This application claims the benefit of Korean Patent Application No. 10-2004-0091838, filed on Nov. 11, 2004, in the Korean Intellectual Property Office, the disclosure of which is incorporated herein in its entirety by reference.

1. Field of the Invention

The present invention relates to a network, and more particularly, to a security router system used for the network and a method of authenticating a user who connects to the system.

2. Description of the Related Art

Routers are devices that transfer data between networks that use the same transport protocol, connect between network layers, maintain a routing table, and transfers data packets.

Conventional fast router systems for increasing routing speed have a dispersion type router structure.

Security service providers provide companies with network security using security products such as intrusion detection systems, firewalls, anti-virus software, etc. However, routers are required to provide a network security function in order to prevent network paralysis caused by harmful network traffic.

### SUMMARY OF THE INVENTION

The present invention provides a security router system providing a network security function and a method of authenticating a user who connects to the system.

According to an aspect of the present invention, there is provided a security router system providing a network security function, the system comprising: a plurality of physical link ports inputting/outputting packets; a physical layer matching unit transmitting/receiving packets to the physical link ports and generating a media access control (MAC) frame; and a network processor comprising routing processing means that establishes a transport route for input packets via the physical layer matching unit and processes routing protocols, packet forwarding means that forward the input packets to their destinations, intrusion detection means that classifies the input packets based on a packet classification standard and determines whether the input packets are attacks from outside, and user authentication means that determine whether a user is authorized to connect to a router.

The system may further comprise: an encryption processor performing a fast encryption operation for a user authentication function and a virtual private network service function, and the system may further comprise: a virtual private network processor providing the virtual private network function for generating a secure communication channel with an external network based on a predetermined protocol.

According to another aspect of the present invention, there is provided a method of authenticating a user who connects to a security router system providing a network security function, the method comprising: receiving an ID and password of the user who connects to the security router system via a predetermined communication network using a client that executes a program generating an encryption according to a predetermined algorithm; generating an encryption text using the input ID and password according to the same algorithm as that of the program executed in the client; receiving an encryption text of the user generated by the client using both the input ID and password; comparing the generated encryption text with the received encryption text; and if the two encryption texts are identical to each other, authenticating and authorizing the user.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a security router system providing a network security function according to an embodiment of the present invention;

FIG. 2 is a block diagram of a security router system providing a network security function according to another embodiment of the present invention;

FIG. 3 is a block diagram of the inside of a network processor according to an embodiment of the present invention;

FIG. 4 is a block diagram illustrating intrusion detection means according to an embodiment of the present invention; and

FIG. 5 is a flowchart illustrating a method of authenticating a user using user authentication means according to an embodiment of the present invention.

### DETAILED DESCRIPTION OF THE INVENTION

The present invention will now be described more fully with reference to the accompanying drawings.

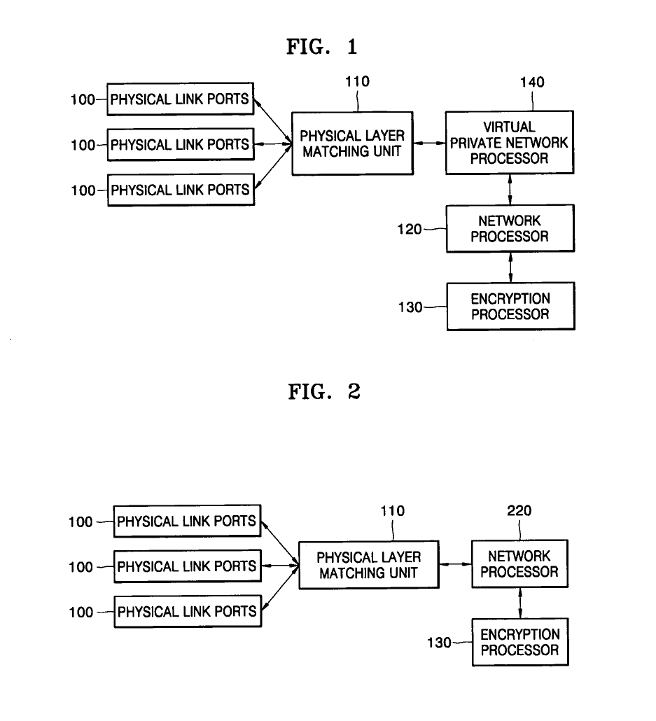

FIG. 1 is a block diagram of a security router system providing a network security function according to an embodiment of the present invention. Referring to FIG. 1, the security router system comprises a plurality of physical link ports 100 that input/output packets, a physical layer matching unit 110 that transmits/receives packets to the physical link ports 100 and generates a media access control (MAC) frame, and a network processor 120 including routing processing means that establishes a transport route for input packets via the physical layer matching unit 110 and processes routing protocols, packet forwarding means that forwards the input packets to their destinations, intrusion detection means that classifies the input packets based on a packet classification standard and determines whether the input packets are attacks from outside, and user authentication means that determine whether a user is authorized to connect to a router.

The router system further comprises an encryption processor 130 that performs a fast encryption operation for a user authentication function and a virtual private network service function, and a virtual private network processor 140 that provides the virtual private network function for generating a secure communication channel with an external network based on a predetermined protocol.

If the physical link ports 100 receive packets, the physical layer matching unit 110 generates the MAC frame.

The virtual private network processor 140 provides the virtual private network service function for generating the secure communication channel with the external network based on the hardware-based predetermined protocol.

If the router system does not comprise the virtual private network processor 140, the physical layer matching unit 110 transmits/receives packets to/from the network processor 120. However, since the router system comprises the virtual private network processor 140, the physical layer matching unit 110 transmits/receives virtual private network processed packets to/from the network processor 120 via the virtual private network processor 140.

The encryption processor 130 performs the fast encryption operation for the user authentication function and the virtual private network service function. The encryption processor 130 is connected to the network processor 120 using a quad data rate (QDR) interface.

Interfaces may be a system packet interface (SPI), a peripheral component interconnect (PCI), the QDR interface, etc. The QDR interface is most effective for transmitting/receiving mass data for processing the encryption between the encryption processor 130 and the network processor 120.

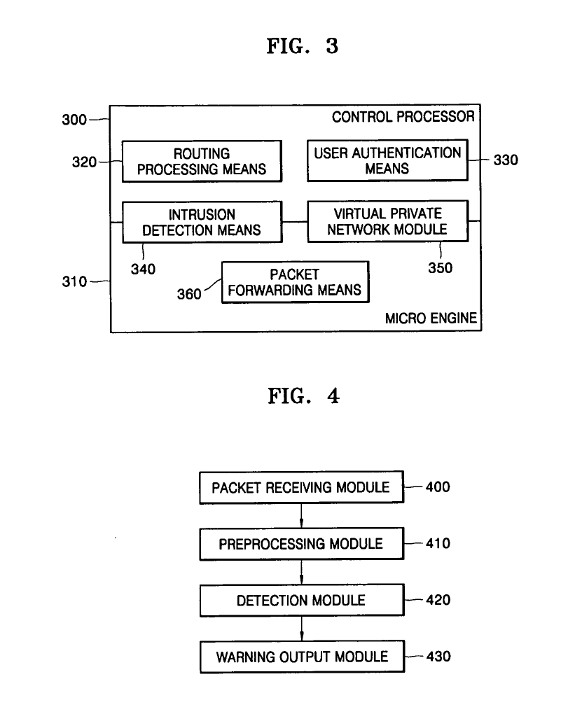

FIG. 2 is a block diagram of a security router system providing a network security function according to another embodiment of the present invention. Referring to FIG. 2, the router system comprises a plurality of physical link ports 100 that input/output packets, a physical layer matching unit 110 that transmits/receives packets to/from the physical link ports 100 and generates a media access control (MAC) frame, and a network processor 220 including routing processing means that establishes a transport route for input packets via the physical layer matching unit 110 and processes routing protocols, packet forwarding means that forwards the input packets to their destinations, intrusion detection means that classifies the input packets based on a packet classification standard and determines whether the input packets are attacks from outside, and user authentication means that determines whether a user is authorized to connect to a router.

The security router system further comprises an encryption processor 130 that performs a fast encryption operation for a user authentication function and a virtual private network service function.

In comparison with the security router system illustrated in FIG. 1, the security router system does not comprise the virtual private network processor 140 illustrated in FIG. 1. The virtual private network processor 140 in FIG. 1 is hardware-based, whereas the network processor 220 in FIG. 2 includes the function of the virtual private network processor 140 and thus is software-based.

The hardware-based virtual private network processor 140 has more expensive parts than non hardware-based virtual private network processors. Therefore, it is difficult to constitute the security router system in popular priced products using the hardware-based virtual private network processor 140. The network processor 220 of the security router system illustrated in FIG. 2 includes the virtual private network function for forming the secure communication channel with the external network.

The network processor 220 providing the virtual private network function may be based on an IP security protocol (IPsec).

The IPsec is a framework of open standards for ensuring secure private communications over the Internet, and ensures confidentiality, integrity, and authenticity of data communications across a public network based on standards.

Whether or not to include the virtual private network processor is the most important cost factor in constituting the security router system as described with reference to FIGS. 1 and 2.

A security router system constituting of a plurality of systems increases manufacturing costs. If a physical layer device, a hardware-based virtual private network device, and a network processor device of the present invention are separated, individual system equipment can be recycled.

In detail, a network processor, peripheral memory logic devices, and controllers form a dotter board, a virtual private network device forms a daughter board, an encryption processor forms a daughter board, and a physical link and physical layer matching unit form a daughter board, such that the daughter boards are matched to constitute a security router system based on the performance and price of the security router system.

FIG. 3 is a block diagram of the inside of a network processor according to an embodiment of the present invention. Referring to FIG. 3, the network processor comprises a control processor 300 and a micro engine 310 and is hardware-based.

The control processor 300 is a general control CPU, e.g., Strong ARM or Xscale, which establishes an initial process of the network processor and manages the network processor. The micro engine 310 is a plurality of CPUs used to forward packets inside the network processor. The CPUs can be 32-bit CPUs or more, if necessary.

Routing processing means 320 and user authentication means 330 are software modules embedded in the control processor 300. Intrusion detection means 340 and a software-based virtual private network module 350 are modules included in both the control processor 300 and the micro engine 310. Packet forwarding means 360 is a software module included in the micro engine 310.

The functions of the means and modules are described with regard to the network processor or the virtual private network processor.

The intrusion detection means 340 may comprise a packet receiving module 400 that receives packets from the physical layer matching unit 110 and converts the received packets suitable for a link level protocol, and converts the packets into higher protocols including a transmission control protocol (TCP) and a user datagram protocol (UDP), a preprocessing module 410 that searches for a packet to be determined among the packets received from the packet receiving module 400, and normalizing a packet having a different protocol before transferring the packets, a detection module 420 that receives the packet normalized by the preprocessing module 410 and checks detailed fields of the received packet, and a warning output module 430 that outputs a warning of a harmful packet if the received packet includes the harmful packet after checking detailed fields of the received packet.

FIG. 4 is a block diagram illustrating the intrusion detection means 340 according to an embodiment of the present invention. Referring to FIG. 4, the packet receiving module 400 is embodied in the micro engine 310 since it is related to the packet forwarding means 360.

The user authentication means 330 of the network processor may comprise an encryption generating unit that generates an encryption text according to a predetermined method using an ID and a password input by a user who connects to a predetermined communication network, an encryption key receiving unit that receives a value of a key encrypted by a user client according to a method used by the encryption generating unit using the ID and the password of the user, and a final authentication unit that compares the encryption text generated by the encryption generating unit with the value of the key received by the encryption key receiving unit and authorizes the user if the encryption text and the value of the key are identical to each other (the inside structure of the user authentication means is not separately illustrated).

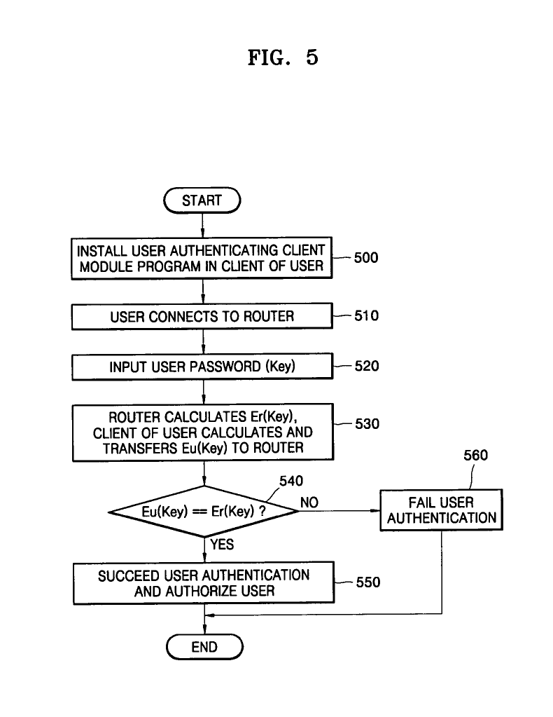

FIG. 5 is a flowchart illustrating a method of authenticating a user using the user authentication means according to an embodiment of the present invention. Referring to FIG. 5, Eu and Er denotes encryption.

A user authenticating client module program is installed in a client of a user (Operation 500). Such an installation is performed directly by a system manager or the user, or by downloading data via a network. The user authenticating client module program generates an encryption according to a predetermined algorithm using an ID and a password input by the user. The encryption can be generated only using the password, if necessary.

The ID and password are established in the security router system of the present invention after being registered by the user or using a separate registration. The registered ID and password can be used from the security router system if necessary.

The user connects to the security router system of the present invention from the client using, for example, a program supporting Telnet (Operation 510).

The user authenticating client module program needs to sense the user who is connecting to the security router system automatically or according to a user's selection when the user connects to the security router system via Telnet.

If the user inputs the ID and the password to connect to the security router system (Operation 520), the ID and password are transferred to the user authentication means 330 of the security router system to calculate an encryption text Er(Key) using the input ID and password according to the same algorithm as that of a program executed in the client (Operation 530). The encryption text Er(Key) can be calculated using the input password, if necessary.

The ID and password are input by the user using a user interface on the screen of the client and transferred to the security router system. At the same time, the user authenticating client module program installed in the client calculates an encryption text Eu(Key) using the input ID and password or the password according to the predetermined algorithm and transfers the calculation result to the security router system. With the encryption text Eu(Key), the ID and password may be transferred.

The encryption algorithm is not restricted thereto, but may be a conventional algorithm or a commercial algorithm.

The user authentication means 330 compares the received value Eu(Key) with the calculated value Er(Key) (Operation 540). If they are identical to each other, then the authentication is successful, and the user is authorized (Operation 550). A general user or the system manager can be authorized based on user information registered in the security router system.

If the received value Eu(Key) is not identical to the calculated value Er(Key), the authentication fails (Operation 550), and a subsequent process is performed, e.g. Telnet is disconnected from the user.

The security router system of the present invention authenticates a registered user and allows an authorized user to connect to a client.

The present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves. The computer readable recording medium can also be distributed network coupled computer systems so that the computer readable code is stored and executed in a distributed fashion. Also, functional programs, codes and code segments for accomplishing the present invention can be easily construed by a programmer skilled in the art to which the present invention pertains.

The operations of the present invention can be realized on a hardware or software basis using a programming system which can be understood by those skilled in the art.

The security routing system of the present invention comprises a plurality of physical link ports that input/output packets, a physical layer matching unit that transmits/receives packets to the physical link ports and generates a MAC frame, and a network processor including routing processing means that establishes a transport route of input packets via the physical layer matching unit and processes routing protocols, packet forwarding means that forward the input packets to their destinations, intrusion detection means that classify the input packets based on a packet classification standard and determines whether the input packets are attacks from outside, and user authentication means that determine whether a user is authorized to connect to a router, thereby reducing expenses required to build a network while maintaining security in comparison with a conventional firewall or intrusion detection system, and increasing reliability and safety of the network by preventing harmful traffic since each router performs a network security function.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the present invention is defined not by the detailed description of the invention but by the appended claims, and all differences within the scope of the present invention will be construed as being included in the present invention.

What is claimed is:

1. A security router system providing a network security function, the system comprising:
a plurality of physical link ports inputting/outputting packets;
a physical layer matching unit transmitting/receiving packets to the physical link ports and generating a media access control (MAC) frame; and
a network processor comprising routing processing means that establishes a transport route for input packets via the physical layer matching unit and processes routing protocols, packet forwarding means that forward the input packets to their destinations, intrusion detection means that classifies the input packets based on a packet classification standard and determines whether the input packets are attacks from outside, and user authentication means that determine whether a user is authorized to connect to a router.

2. The system of claim 1, further comprising: an encryption processor performing a fast encryption operation for a user authentication function and a virtual private network service function.

3. The system of claim 2, wherein the encryption processor is connected to the network processor using a quad data rate (QDR) interface.

4. The system of claim 1, further comprising: a virtual private network processor providing the virtual private network function for generating a secure communication channel with an external network based on a predetermined protocol.

5. The system of claim 4, wherein the virtual private network processor provides the virtual private network function based on an IP security protocol (IPsec).

6. The system of claim 1, wherein the intrusion detection means of the network processor comprises:
a packet receiving module receiving packets from the physical layer matching unit and converting the received packets suitable for a link level protocol, and converting the packets into higher protocols including a transmission control protocol (TCP) and a user datagram protocol (UDP);
a preprocessing module searching for a packet to be determined among the packets received from the packet receiving module, and normalizing a packet having a different protocol before transferring the packets;
a detection module receiving the packet normalized by the preprocessing module and checking detailed fields of the received packet; and
a warning output module outputting a warning of a harmful packet if the received packet includes the harmful packet after checking detailed fields of the received packet.

7. The system of claim 1, wherein the user authentication means of the network processor comprises:
an encryption generating unit generating an encryption text according to a predetermined method using an ID and a password input by a user who connects to a predetermined communication network;
an encryption key receiving unit receiving a value of a key encrypted by a user client according to a method used by the encryption generating unit using the ID and the password of the user; and
a final authentication unit comparing the encryption text generated by the encryption generating unit with the value of the key received by the encryption key receiving unit and authorizes the user if the encryption text and the value of the key are identical to each other.

8. A method of authenticating a user who connects to a security router system providing a network security function, the method comprising:
receiving an ID and password of the user who connects to the security router system via a predetermined communication network using a client that executes a program generating an encryption according to a predetermined algorithm;
generating an encryption text using the input ID and password according to the same algorithm as that of the program executed in the client;
receiving an encryption text of the user generated by the client using both the input ID and password;
comparing the generated encryption text with the received encryption text; and
if the two encryption texts are identical to each other, authenticating and authorizing the user.
